(19) United States
(12) Patent Application Publication
(10) Pub. No.: US 2006/0194564 A1
(43) Pub. Date: Aug. 31, 2006

(54) Radio transmitting/receiving apparatus and intermittent transmission/reception control method of radio transmitting/receiving apparatus

(76) Inventors: Takehiro Hokimoto, Tokyo (JP); Daisuke Kawasaki, Tokyo (JP); Masanobu Arai, Tokyo (JP); Kaname Kojima, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/565,835

(22) PCT Filed: Jul. 29, 2004
(86) PCT No.: PCT/JP04/10834

§ 371 Date: Jan. 25, 2006

(30) Foreign Application Priority Data
Jul. 30, 2003 (JP) 2003-283081
Oct. 28, 2003 (JP) 2003-367577

(51) Int. Cl. H04B 1/16; H04B 1/38

(52) U.S. Cl. 455/343.2; 455/574

(57) ABSTRACT

A radio transmitter/receiver and an intermittent transmission/reception control method thereof, capable of reducing the reception startup time as well as suppressing reception power consumption. A radio transmitter/receiver used for ad hoc communication is provided with a dedicated standby reception unit (10) having a simple combination of an RF demodulator (6) and a SAW oscillator (7) only to detect a carrier. For a time period of several bits, the activation system of the radio transmitter/receiver intermittently receives activation selection signals transmitted using ASK (or OOK) modulation prior to a preamble signal, and makes an activation selection based on the pattern of presence and absence of the carriers of the signals. As a result, the reception startup time can be shortened, and less reception power is required.

### TECHNICAL FIELD

The present invention relates to a radio transmitter/receiver, and an intermittent transmission/reception control method thereof.

### BACKGROUND ART

In the case of collecting data (every type of sensing data including environmental data such as temperature, humidity, acceleration and CO₂ concentration, image data such as an image of a river in flood, location information data, etc.) with battery-powered wireless sensor modules or the like through ad hoc communication, the battery survival time needs to be prolonged by minimizing standby power consumption to reduce average power consumption.

There has been an intermittent transmission/reception control system in which a preamble is detected in signals from other transmitters, well-known as a method of reducing power consumption on standby for reception.

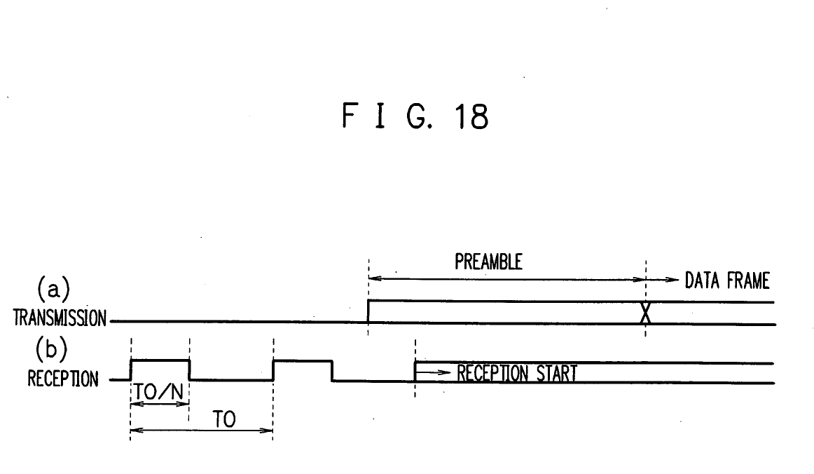

FIG. 17 is a block diagram showing a radio transmitter/receiver to which is applied a conventional intermittent transmission/reception control method. FIG. 18 (a) is a diagram showing the signal timing at the time of the transmission operation of the radio transmitter/receiver depicted in FIG. 17, and FIG. 18 (b) is a diagram showing the signal timing at the time of the reception operation of the radio transmitter/receiver depicted in FIG. 17. In FIGS. 18 (a) and 18 (b), the horizontal axis indicates time, while the vertical axis indicates signal level.

Referring to FIG. 17, the radio transmitter/receiver to which is applied a conventional intermittent transmission/reception control method comprises an antenna 1, a transmission/reception changeover switch 2, a radio transmission unit 3, a radio reception unit 4, an oscillator circuit 5, a carrier detector 8, and an intermittent operation controller 11.

The radio transmission and reception units shown in FIG. 17 employs as the oscillator circuit a quartz-crystal oscillator, which requires a considerable amount of time for the stabilization of the oscillation after the power is turned on (see FIGS. 18 (a) and 18 (b)). Consequently, the radio transmitter/receiver cannot shorten the time necessary for intermittent reception, and wastes the reception power.

Besides, the conventional radio transmitter/receiver enters reception mode after the carrier sense of ID for intermittent preamble detection. Therefore, the radio transmitter/receiver reacts to unwanted signals, and frequently performs ID check, which often causes an increase in average power consumption.

In the following, “unwanted signal” will be described.

Referring to FIG. 18 (a), a signal consisting of a preamble and data is transmitted from the sending end. Generally, ID data is embedded in a preamble signal. Having received the ID data, the receiving end determines whether or not the signal is transmitted thereto. Accordingly, the receiving end frequently checks (detects) preamble signals even if they are addressed to other destinations. The signal addressed to another destination is herein referred to as “unwanted signal”.

Further, in the case of 1/N (T0/N period in reception at T0 intervals) intermittent reception, the conventional radio transmitter/receiver cannot recognize ID unless the preamble is 8*N bits or more in length with respect to, for example, 8-bit ID.

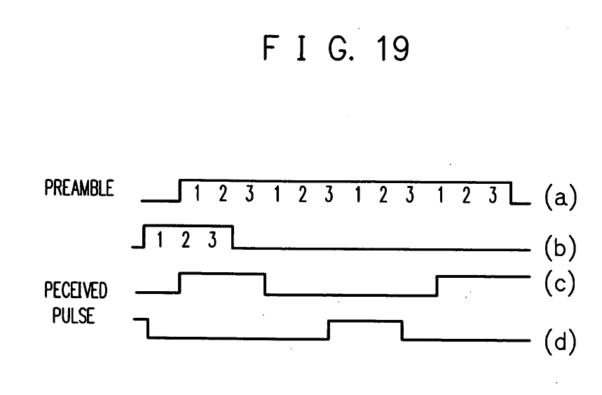

The reason will be explained referring to FIGS. 19 (a) to 19 (d).

FIGS. 19 (a) and 19 (b) each show a preamble where ID=3 bits and N=4 detected by the radio transmitter/receiver depicted in FIG. 17, and FIGS. 19 (c) and 19 (d) each show a received pulse in the same conditions as above. In FIGS. 19 (a) to 19 (d), the horizontal axis indicates time, while the vertical axis indicates logical level.

Intermittently-received pulses are generated at 12-bit intervals, each having a width of 3 bits (N=4). As can be seen in FIGS. 19 (c) and 19 (d), it is indeterminable where the intermittently-received pulse rises with respect to the preamble shown in FIG. 19 (a). When a preamble containing ID 1, 2, 3 is received with such intermittently-received pulses, if the preamble is 3 bits wide as shown in FIG. 19 (b), the ID thereof cannot be recognized. That is, to recognize ID with the pulse shown in FIGS. 19 (c) or 19 (d), the preamble has to be 3*4=12 bits or more in width as shown in FIG. 19 (a).

As just described, it is not until having detected ID of a preamble that the conventional radio transmitter/receiver determines whether or not to be activated. Consequently, when the activation of others frequently occurs, the radio transmitter/receiver consumes power wastefully, resulting in an increase in average power consumption.

Against such a background, there has been proposed a radio transmitter/receiver aimed at reducing main power consumption in terms of circuits. The radio transmitter/receiver comprises a transmitter for generating and transmitting a prescribed bit pattern prior to an objective transmission signal, a power controller for intermittently supplying power, and a signal processor for issuing an instruction to switch the intermittent power supply to continuous power supply in response to the arrival of a bit pattern (see, for example, Patent Document 1).

In addition, there has been proposed a system for wirelessly checking meters, capable of reliably recognizing the pattern of an activation signal with high-speed response. The system comprises a radio master unit and a plurality of radio slave units each connected to a meter. An activation signal transmitted form the radio master unit consists of the repetition of a synchronous signal unique to the system and a self-identification signal subsequent to the synchronous signal. Each of the radio slave units detects the synchronous signal and self-identification signal from at least one activation signal, and recognizes significant communication in the system, thereby establishing a radio channel (see, for example, Patent Document 2).

Patent Document 1: Japanese Patent Laid-Open No. SH061-33027

Patent Document 2: Japanese Patent Laid-Open No. 2001-160990

### DISCLOSURE OF THE INVENTION

### Problems that the Invention is to Solve

However, also in the conventional technologies described above, a considerable amount of time is taken to initiate reception, and reception power is wastefully consumed.

It is therefore an object of the present invention to provide a radio transmitter/receiver and an intermittent transmission/reception control method thereof, capable of reducing the time taken to initiate reception or reception startup time as well as suppressing reception power consumption.

### Means of Solving the Problems

In accordance with the first aspect of the present invention, to achieve the object mentioned above, there is provided a radio transmitter/receiver which requires less reception standby power, comprising: a radio reception unit; a radio transmission unit for transmitting an activation selection signal using ASK (Amplitude Shift Keying) modulation or OOK (On/Off Keying) modulation to switch the radio reception unit of another radio transmitter/receiver from intermittent reception mode to continuous reception mode before transmitting a preamble signal thereto; and a standby reception unit for intermittently performing reception at intervals of a prescribed bit width to receive an activation selection signal from the radio transmission unit of another radio transmitter/receiver, and generating a signal to activate the radio reception unit on receipt of the activation selection signal.

In accordance with the second aspect of the present invention, in the first aspect, the standby reception unit includes a SAW (Surface Acoustic Wave) oscillator for completing reception in a time period of a prescribed bit width from when the power is turned on, and the use of a signal generated by the SAW oscillator reduces the reception startup time of the radio reception unit.

In accordance with the third aspect of the present invention, in the second aspect, the SAW oscillator is provided with a frequency selector for selecting the oscillation frequency thereof.

In accordance with the fourth aspect of the present invention, in one of the first to third aspects, the radio transmitter/receiver further comprises a power controller. The radio transmission unit adds an ID signal that specifies the receiver to the activation selection signal. The standby reception unit determines whether or not the received activation selection signal is addressed to the radio transmitter/receiver based on an ID signal added to the activation selection signal. The power controller feeds power to the radio transmission unit and the radio reception unit only when the standby reception unit has determined that the activation selection signal is addressed to the radio transmitter/receiver.

In accordance with the fifth aspect of the present invention, in the fourth aspect, the ID signal includes a group ID signal and/or an individual ID signal.

In accordance with the sixth aspect of the present invention, there is provided a radio transmitter, including a radio transmission unit for transmitting an activation selection signal using ASK modulation or OOK modulation to switch the radio reception unit of a radio receiver from intermittent reception mode to continuous reception mode before transmitting a preamble signal thereto.

In accordance with the seventh aspect of the present invention, in the sixth aspect, the radio transmission unit adds an ID signal that specifies the receiver to the activation selection signal.

In accordance with the eighth aspect of the present invention, there is provided a radio receiver which requires less reception standby power, comprising: a radio reception unit; and a standby reception unit for intermittently performing reception at intervals of a prescribed bit width to receive an activation selection signal transmitted using ASK modulation or OOK modulation prior to a preamble signal, and generating a signal to activate the radio reception unit on receipt of the activation selection signal.

In accordance with the ninth aspect of the present invention, in the eighth aspect, the standby reception unit includes a SAW oscillator for completing reception in a time period of a prescribed bit width from when the power is turned on, and the use of a signal generated by the SAW oscillator reduces the reception startup time of the radio reception unit.

In accordance with the tenth aspect of the present invention, in the ninth aspect, the SAW oscillator is provided with a frequency selector for selecting the oscillation frequency thereof.

In accordance with the eleventh aspect of the present invention, in one of the eighth to tenth aspects, the radio receiver further comprises a power controller. The standby reception unit determines whether or not the received activation selection signal is addressed to the radio receiver based on an ID signal added to the activation selection signal. The power controller feeds power to a radio transmission unit and the radio reception unit only when the standby reception unit has determined that the activation selection signal is addressed to the radio receiver.

In accordance with the twelfth aspect of the present invention, in the eleventh aspect, the ID signal includes a group ID signal and/or an individual ID signal.

In accordance with the thirteenth aspect of the present invention, there is provided an intermittent transmission/reception control method applied to a radio transmitter/receiver comprising a radio reception unit, a radio transmission unit and a standby reception unit for reducing reception standby power, the method comprising the steps of: the radio transmission unit transmitting an activation selection signal using ASK modulation or OOK modulation to switch the radio reception unit of another radio transmitter/receiver from intermittent reception mode to continuous reception mode before transmitting a preamble signal thereto; the standby reception unit intermittently performing reception at intervals of a prescribed bit width to receive an activation selection signal from the radio transmission unit of another radio transmitter/receiver; and the standby reception unit generating a signal to activate the radio reception unit on receipt of the activation selection signal.

In accordance with the fourteenth aspect of the present invention, in the thirteenth aspect, the standby reception unit includes a SAW oscillator for completing reception in a time period of a prescribed bit width from when the power is turned on. The intermittent transmission/reception control method further comprises the step of the standby reception unit using a signal generated by the SAW oscillator to reduce the reception startup time of the radio reception unit.

In accordance with the fifteenth aspect of the present invention, in the fourteenth aspect, the SAW oscillator is provided with a frequency selector. The intermittent transmission/reception control method further comprises the step of the frequency selector selecting the oscillation frequency of the SAW oscillator.

In accordance with the sixteenth aspect of the present invention, in one of the thirteenth to fifteenth aspects, the intermittent transmission/reception control method further comprises the steps of: the radio transmission unit adding an ID signal that specifies the receiver to the activation selection signal; the standby reception unit determining whether or not the received activation selection signal is addressed to the radio transmitter/receiver based on an ID signal added to the activation selection signal; and a power controller feeding power to the radio transmission unit and the radio reception unit only when the standby reception unit has determined that the activation selection signal is addressed to the radio transmitter/receiver.

In accordance with the seventeenth aspect of the present invention, in the sixteenth aspect, the ID signal includes a group ID signal and/or an individual ID signal.

In accordance with the eighteenth aspect of the present invention, there is provided an intermittent transmission control method, comprising the step of the radio transmission unit of a radio transmitter transmitting an activation selection signal using ASK modulation or OOK modulation to switch the radio reception unit of a radio receiver from intermittent reception mode to continuous reception mode before transmitting a preamble signal thereto.

In accordance with the nineteenth aspect of the present invention, in the eighteenth aspect, the intermittent transmission control method further comprising the step of the radio transmission unit adding an ID signal that specifies the receiver to the activation selection signal.

In accordance with the twentieth aspect of the present invention, there is provided an intermittent reception control method for reducing reception standby power, comprising the steps of: the standby reception unit of a radio receiver intermittently performing reception at intervals of a prescribed bit width to receive an activation selection signal transmitted using ASK modulation or OOK modulation prior to a preamble signal; and the standby reception unit generating a signal to activate the radio reception unit of the radio receiver on receipt of the activation selection signal.

In accordance with the twenty-first aspect of the present invention, in the twentieth aspect, the standby reception unit includes a SAW oscillator for completing reception in a time period of a prescribed bit width from when the power is turned on. The intermittent reception control method further comprises the step of the standby reception unit using a signal generated by the SAW oscillator to reduce the reception startup time of the radio reception unit.

In accordance with the twenty-second aspect of the present invention, in the twenty-first aspect, the SAW oscillator is provided with a frequency selector. The intermittent reception control method further comprises the step of the frequency selector selecting the oscillation frequency of the SAW oscillator.

In accordance with the twenty-third aspect of the present invention, in one of the twentieth to twenty-second aspects, the intermittent reception control method further comprises the steps of: the standby reception unit determining whether or not the received activation selection signal is addressed to the radio receiver based on an ID signal added to the activation selection signal; and a power controller feeding power to a radio transmission unit and the radio reception unit only when the standby reception unit has determined that the activation selection signal is addressed to the radio receiver.

In accordance with the twenty-fourth aspect of the present invention, in the twentieth aspect, the ID signal includes a group ID signal and/or an individual ID signal.

<Operation>

A radio transmitter/receiver used for ad hoc communication includes a dedicated standby reception unit having a simple combination of a demodulator and a SAW oscillator only to detect a carrier. For a time period of several bits, the activation system of the radio transmitter/receiver intermittently receives activation selection signals transmitted using ASK (or OOK) modulation prior to a preamble signal, and makes an activation selection based on the pattern of presence and absence of the carriers of the signals. As a result, the reception startup time can be reduced, and less reception power is required.

In addition, the transmission and reception units are not provided with power until an ID pattern recognition unit recognizes ID, which enables reception standby power to be reduced.

### Effect of the Invention

A radio transmitter/receiver to which is applied an intermittent transmission/reception control method of the present invention is provided with a dedicated standby reception unit using a SAW oscillator. By virtue of this construction, the radio transmitter/receiver makes fast reception startup and becomes ready for reception within a few seconds, thereby wasting no reception power. Besides, only minimum circuits (a standby reception unit, a pattern comparator and an intermittent operation controller) necessary for receiving an activation selection signal are in operation before a radio reception unit is turned on due to the recognition of an activation selection signal to the radio transmitter/receiver. Accordingly, the radio transmitter/receiver consumes very little power by receiving unwanted signals. Further, the radio transmitter/receiver can receive a preamble signal from the first bit, and minimize the time taken to transmit the preamble signal, thus reducing the transmission power. Still further, the transmission and reception units are not provided with power until an ID pattern recognition unit recognizes ID, which enables reception standby power to be reduced.

### BEST MODE FOR CARRYING OUT THE INVENTION

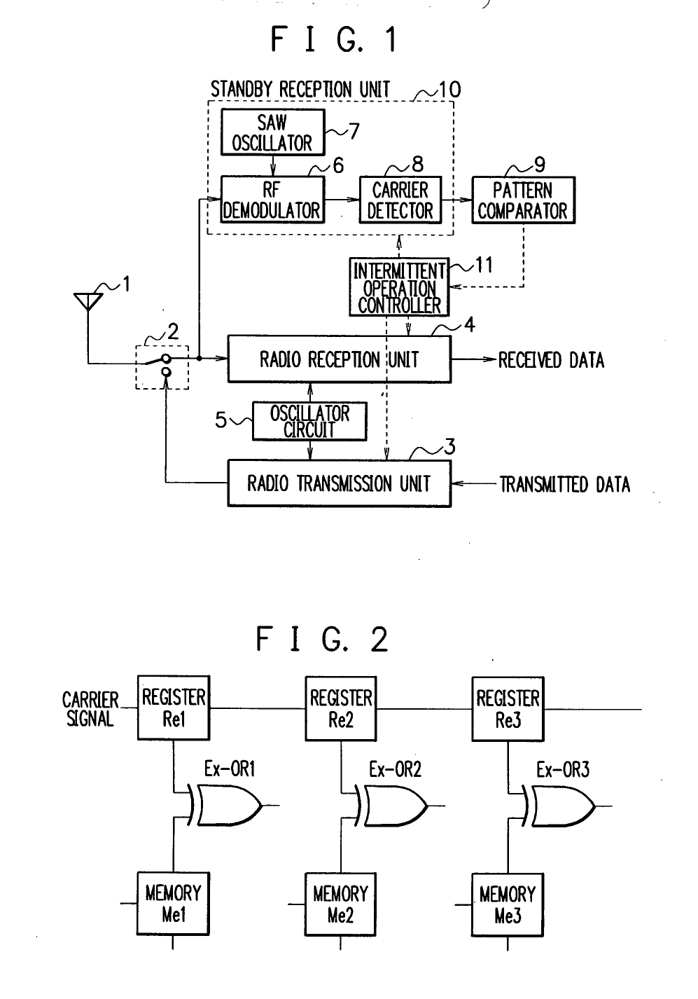

FIG. 1 is a block diagram showing a radio transmitter/receiver to which is applied an intermittent transmission/reception control method for a radio transmitter/receiver according to an embodiment of the present invention.

The radio transmitter/receiver mainly comprises an antenna 1, a transmission/reception changeover switch 2, a radio transmission unit 3, a radio reception unit 4, and an oscillator circuit 5. The radio transmitter/receiver further comprises, in addition to the radio reception unit 4, a standby reception unit 10 including an RF (Radio Frequency) demodulator 6, a SAW oscillator 7, and a carrier detector 8. The radio transmitter/receiver yet further comprises a pattern comparator 9 for comparing the pattern of presence and absence of the carriers with a predetermined pattern, and an intermittent operation controller 11 for controlling the intermittent operation of the respective radio transmission unit 3, radio reception unit 4, oscillator circuit 5 and standby reception unit 10. The frequencies of radio waves used by the radio transmitter/receiver include all frequencies that can be generated by the SAW oscillator 7.

The antenna 1 may be an omnidirectional antenna such as a whip antenna and a dipole antenna, or a directional antenna such as a Yagi antenna and a loop antenna.

The transmission/reception changeover switch 2 connects the antenna 1 to the radio transmission unit 3 at the time of transmission, and connects it to the radio reception unit 4 and the RF demodulator 6 at the time of reception. As the transmission/reception changeover switch 2 may be employed, for example, an analog switch, which is not shown in the drawing.

The radio transmission unit 3 has the function of feeding the antenna 1 with data to be transmitted through the transmission/reception changeover switch 2. Besides, the radio transmission unit 3 has the function of transmitting at regular intervals an activation selection signal using ASK (or OOK) modulation to switch the radio reception unit of another radio transmitter/receiver (not shown) from intermittent reception mode to continuous reception mode before transmitting a preamble signal thereto

The radio reception unit 4 has a function of receiving radio waves from the antenna 1 to extract received data therefrom.

The oscillator circuit 5 has a function of generating sinusoidal signals at frequencies necessary for the radio transmission unit 3 and the radio reception unit 4.

The RF demodulator 6 has a function of demodulating a high-frequency signal (RF signal) at a necessary frequency in radio waves from the antenna 1.

The SAW oscillator 7 is configured with a SAW (Surface Acoustic Wave) device, and has a function of producing oscillations in a frequency band ranging from 10 MHz to several GHz. The carrier detector 8 has a function of detecting a carrier from the output signals of the RF demodulator 6.

The pattern comparator 9 has a function of comparing the pattern (the pattern of a combination of H “logical level 1” and L “logical level 0”) of a signal output from the carrier detector 8 with a predetermined pattern. The pattern comparator 9 compares, for example, the pattern “01010001” of an input 8-bit signal with an 8-bit signal comparison pattern. If the comparison pattern is “01010001” and the two patterns match, the pattern comparator 9 outputs a match signal. The pattern comparator 9 is configured with, for example, exclusive-OR (EXOR) gates, registers and memories.

Referring now to FIG. 2, a description will be given in detail of the case where the pattern comparator 9 compares a 3-bit pattern “101” and pre-stored data.

FIG. 2 is a block diagram showing an example of the pattern comparator of the radio transmitter/receiver depicted in FIG. 1.

The pattern comparator includes three exclusive-OR gates Ex-OR 1, Ex-OR 2 and Ex-OR 3, three registers Re 1, Re 2 and Re 3 whose output terminals are connected to one inputs (on the upper side in FIG. 2) of the EXOR gates Ex-OR 1 to Ex-OR 3, respectively, and three memories Me 1, Me 2 and Me 3 whose output terminals are connected to the other inputs (on the lower side in FIG. 2) of the EXOR gates Ex-OR 1 to Ex-OR 3, respectively.

The memory Me 1 stores “1”, the memory Me 2 stores “0”, and the memory Me 3 stores “1”. The registers Re 1, Re 2 and Re 3 sequentially forward data on a carrier signal detection cycle (from the register Re 1 to the register Re 2, from the register Re 2 to the register Re 3, and from the register Re 3 to the next stage). As the memories Me 1 to Me 3 may be used ROMs (Read Only Memories), RAMs (Random Access Memories), etc. without limitation if only capable of output at a prescribed level. It is assumed that comparison patterns have been previously written to the memories Me 1 to Me 3.

In this construction, the pattern comparison is performed as follows:

Step (1): “1” is detected as a carrier Data in the register Re 1 is “1”, while data in the registers Re 2 and Re 3 are “X”, i.e., indefinite. Consequently, the EXOR gate Ex-OR 1 outputs “1”, while the EXOR gates Ex-OR 2 and Ex-OR 3 output “X”. Thereby, the EXOR gate Ex-OR 1 compares the output of the register Re 1 with that of the memory Me 1. If they match, the EXOR gate Ex-OR 1 outputs “1”. Otherwise, the EXOR gate Ex-OR 1 outputs “0”. The other EXOR gates Ex-OR 2 and Ex-OR 3 operate in the same manner as the EXOR gate Ex-OR 1.

Step: (2) “0” is detected as a carrier after Step (1)

Data in the register Re 1 is “0”, data in the register Re 2 is “1”, and data in the register Re 3 is “X”. Consequently, the EXOR gate Ex-OR 1 outputs “0”, the EXOR gate Ex-OR 2 outputs “1”, and the EXOR gate Ex-OR 3 outputs “X”.

Step (3): “1” is detected as a carrier after Step (2)

Data in the register Re 1 is “1”, data in the register Re 2 is “0”, and data in the register Re 3 is “1”. Consequently, the EXOR gate Ex-OR 1 outputs “1”, the EXOR gate Ex-OR 2 outputs “0”, and the EXOR gate Ex-OR 3 outputs “1”. If all the outputs of the EXOR gates Ex-OR 1 to Ex-OR 3 (e.g. the AND of all the outputs) indicate “1”, it can be determined that the contents of the memories Me 1 to Me 3 match those of the registers Re 1 to Re 3.

The standby reception unit 10 includes the RF demodulator 6, the SAW oscillator 7, and the carrier detector 8.

The standby reception unit 10 has a function of intermittently performing reception at intervals of a prescribed bit width (several bits) to receive an activation selection signal from the radio transmission unit of another radio transmitter/receiver, and activating the radio reception unit 4 on receipt of the activation selection signal.

The intermittent operation controller 11 has a function of controlling the operation of the radio transmission unit 3, radio reception unit 4, and standby reception unit 10. More specifically, under the control of the intermittent operation controller 11, the radio transmission unit 3 transmits an activation selection signal using ASK modulation or OOK modulation at regular intervals to switch the radio reception unit of another radio transmitter/receiver from intermittent reception mode to continuous reception mode before transmitting a preamble signal thereto. Besides, having received an activation selection signal from the radio transmission unit of another radio transmitter/receiver, the standby reception unit 10 activates the radio reception unit 4. As the intermittent operation controller 11, for example, a microprocessor may be employed.

### Operation of the Embodiment of the Present Invention

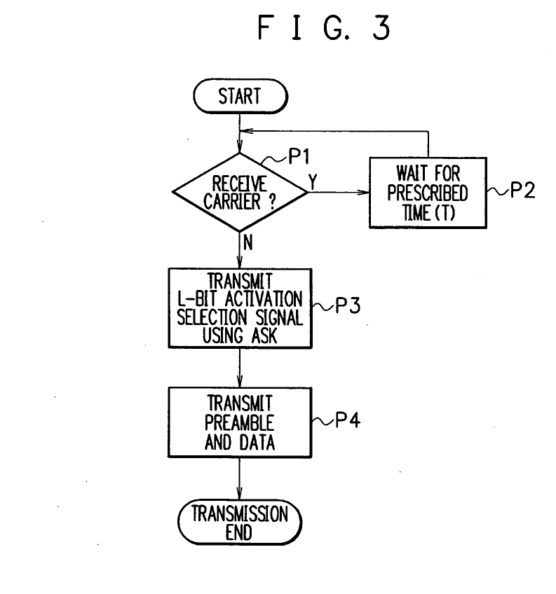

FIG. 3 is a flowchart showing the transmission operation of the radio transmitter/receiver depicted in FIG. 1 for activating another radio transmitter/receiver having the same construction as that of the radio transmitter/receiver depicted in FIG. 1.

When activating another radio transmitter/receiver, the radio transmitter/receiver of FIG. 1 first performs carrier sense to detect a channel (determines whether or not a carrier has been received at an activation frequency) (step P1). If the other radio transmitter/receiver is in use (if a carrier has been received) (step P1/Y), the radio transmitter/receiver waits for a prescribed time period (T) (step P2), and then returns to step P1 to detect a carrier again.

If the other radio transmitter/receiver is not in use (if a carrier has not been received from the other radio transmitter/receiver) (step P1/N), the radio transmitter/receiver of FIG. 1 transmits through the radio transmission unit 3 an L-bit activation selection signal using ASK (Amplitude Shift Keying) modulation or OOK (On/Off Keying) modulation (step P3). After that, the radio transmitter/receiver transmits a preamble signal and communication data (step P4).

The OOk modulation is a kind of the ASK modulation, in which data “1” corresponds to 100% logical level, while data “0” corresponds to 0% logical level (no transmission). In other words, the radio transmission unit of the radio transmitter/receiver is off when data is at a logical level of 0%.

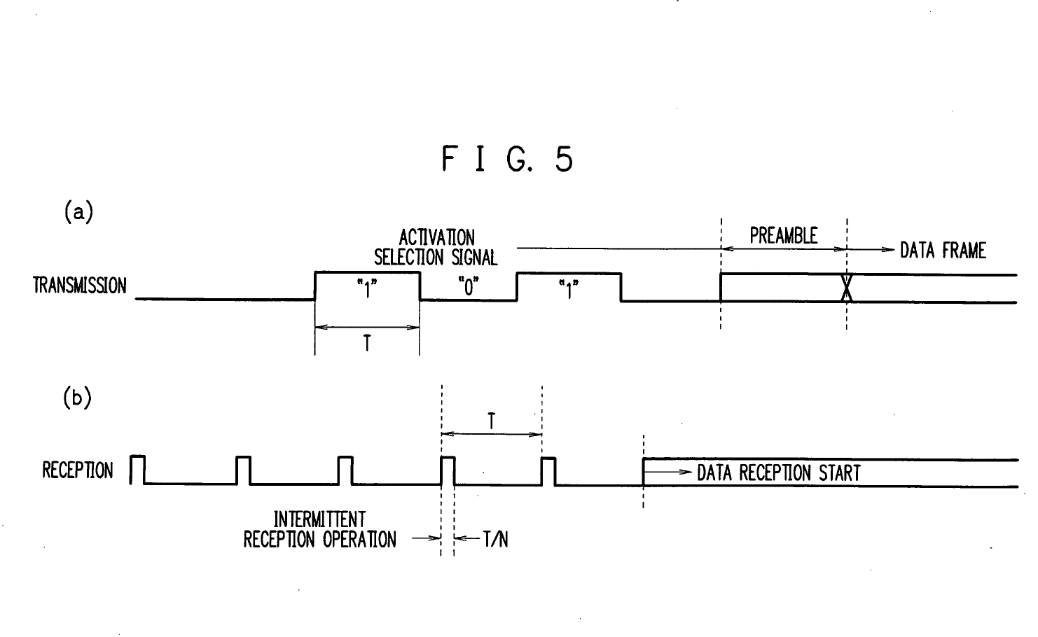

FIG. 5 (a) is a time chart showing the operation in steps P3 and P4. FIG. 5 (b) is a time chart showing the operation at the time of reception. In FIGS. 5 (a) and 5 (b), the L-bit activation selection signal is a 3-bit signal: L=3 (“1”, “0”, “1”), and T indicates the time taken to transmit each bit.

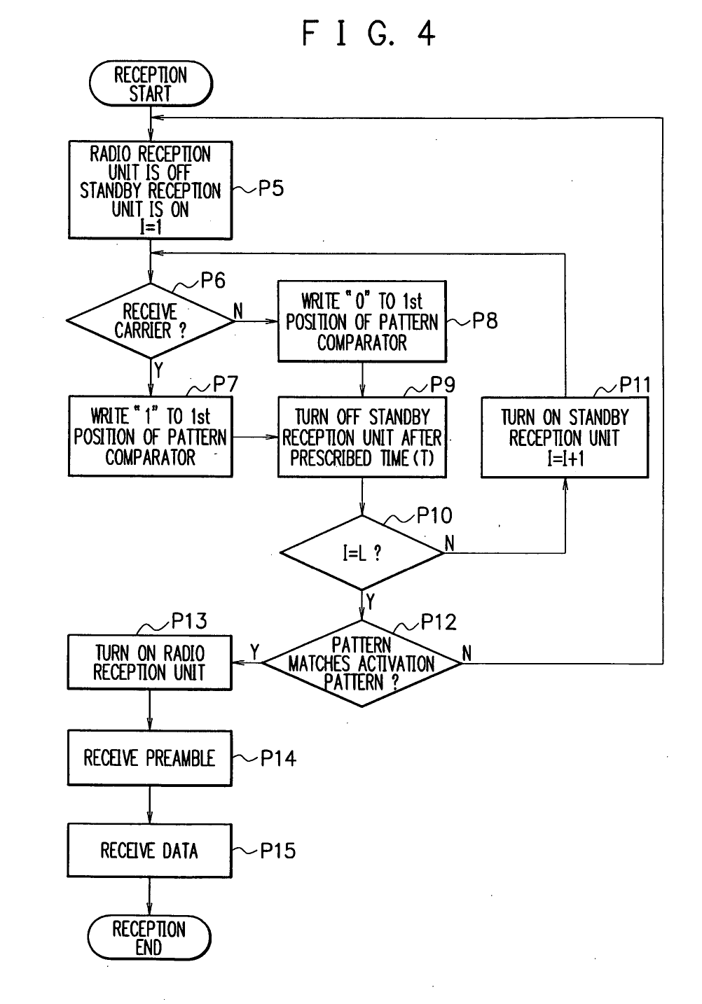

FIG. 4 is a flowchart showing the operation of the radio transmitter/receiver to be activated (the other radio transmitter/receiver) in standby mode.

In standby mode, the radio reception unit (corresponding to the radio reception unit 4 in FIG. 1) of the other radio transmitter/receiver is off (step P5).

The standby reception unit (corresponding to the standby reception unit 10 in FIG. 1) of the other radio transmitter/receiver determines whether or not to have received a carrier (step P6). If a carrier has been received (step P6/Y), the standby reception unit writes “1” to the pattern comparator (corresponding to the pattern comparator 9 in FIG. 1) (step P7). After waiting for a prescribed time period (T), the standby reception unit turns off (step P9).

If a carrier has not been received (step P6/N), the intermittent operation controller (corresponding to the intermittent operation controller 11 in FIG. 1) of the other radio transmitter/receiver writes “0” to the pattern comparator (step P8). After waiting for the prescribed time period (T), the intermittent operation controller turns the standby reception unit off (step P9).

The other radio transmitter/receiver performs the carrier sense at regular intervals (T) for a time period T/N, and writes “1” or “0” as information on the presence or absence of a carrier to the pattern comparator (steps P7, P8, P9, P10 and P11).

After that, the other radio transmitter/receiver determines, when having written an L-bit pattern to the pattern comparator, whether or not I (I: an integer) is equal to L (L: the number of bits of an activation pattern=an activation selection signal) (step P10). If I is equal to L, the other radio transmitter/receiver determines whether or not the L-bit pattern written to the pattern comparator matches the activation pattern (step P12).

If I=L (step P10/Y) and the L-bit pattern written to the pattern comparator matches the activation pattern (step P12/Y), the intermittent operation controller turns the radio reception unit on (step P13). Thereby, the other radio transmitter/receiver receives a preamble signal (step P14) and data (step P15), and completes the reception.

If I≠L (step P10/N), the intermittent operation controller turns the standby reception unit on as well as substituting I+1 into I (step P11). Then, the process returns to step P6.

If the L-bit pattern written to the pattern comparator does not match the activation pattern (step P12/N), the process returns to step P5.

FIG. 5 (b) is a time chart showing the intermittent reception operation in the case where the L-bit activation selection signal is a 3-bit signal: L=3 (“1”, “0”, “1”).

As is described above, in accordance with the present invention, the radio transmitter/receiver transmits an activation selection signal using ASK (or OOK) modulation prior to a preamble signal. On the other hand, the radio transmitter/receiver intermittently receives activation selection signals for a time period of several bits, and makes an activation selection or decides to be active based on the pattern of presence and absence of the carriers of the signals. As a result, the reception startup time can be reduced, and less reception power is required.

### Another Embodiment of the Present Invention

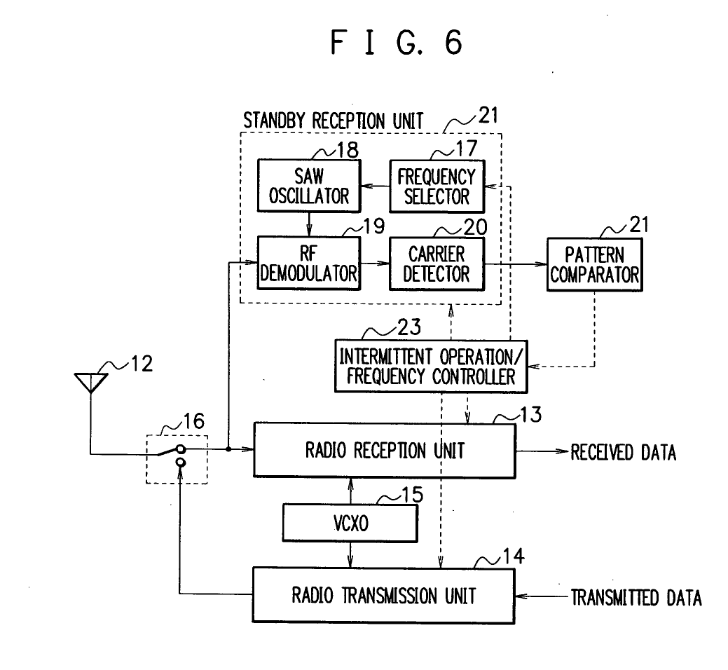

FIG. 6 is a block diagram showing a radio transmitter/receiver provided with a plurality of activation channels according to another embodiment of the present invention.

As can be seen in FIG. 6, differently from the radio transmitter/receiver shown in FIG. 1, the standby reception unit includes a frequency selector. In addition, the radio transmitter/receiver is provided with an intermittent operation/frequency controller in place of the intermittent operation controller and a VCXO (Voltage Controlled Xtal Oscillator) in place of the oscillator circuit.

Referring to FIG. 6, the radio transmitter/receiver mainly comprises an antenna 12, a transmission/reception changeover switch 16, a radio transmission unit 14, a radio reception unit 13, and a VCXO 15. The radio transmitter/receiver further comprises, in addition to the radio reception unit 13, a standby reception unit 21 including an RF demodulator 19, a SAW oscillator 18, a frequency selector 17 for selecting the frequency of the SAW oscillator 18 and a carrier detector 20. The radio transmitter/receiver yet further comprises a pattern comparator 22 for comparing the pattern of presence and absence of the carriers with a predetermined pattern, and an intermittent operation/frequency controller 23 for controlling the frequency selection and intermittent operation of the respective radio transmission unit 14, radio reception unit 13, VCXO 15 and standby reception unit 21.

The VCXO 15 can change the oscillation frequency using, for example, a PLL (Phase-Locked Loop) and a variable capacitance diode.

The intermittent operation/frequency controller 23 has a function of controlling the operation of the radio reception unit 13, radio transmission unit 14, and standby reception unit 21, and operates substantially in the same manner—as the aforementioned intermittent operation controller 11 (see FIG. 1).

The standby reception unit 21 makes use of the characteristic of the SAW oscillator (the SAW oscillator has a characteristic between crystal and LC oscillators, and can directly oscillate signals at frequencies of a plurality of channels with a single SAW device through voltage control), thereby being capable of receiving a plurality of channels with one SAW oscillator.

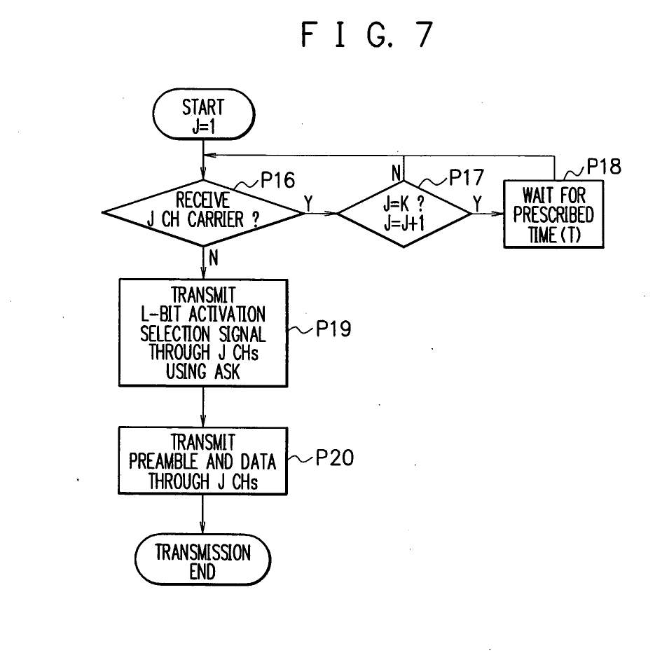

FIGS. 7 to 9 are flowcharts and a time chart showing the operation of the radio transmitter/receiver shown in FIG. 6 at the time of transmission/reception for activation.

When activating another radio transmitter/receiver, the radio transmitter/receiver of FIG. 6 first performs carrier sense to detect a plurality of channels (KCH “K channels”) desired for use (determines whether or not a carrier has been received at an activation frequency of each of K channels: step P16). If a carrier has been received from a channel (step P16/Y), the radio transmitter/receiver determines whether or not J (the number of channels) is equal to K as well as substituting J+1 into J (step P17).

If having determined that J is equal to K (step P17/Y), i.e., K channels are busy, the intermittent operation/frequency controller 23 subtracts 1 from J after waiting for a prescribed time period (T) (step P18), and returns to step P16 to detect a carrier again.

If J is not equal to K (step P17/N), the process returns to step P16.

If the intermittent operation/frequency controller 23 has determined that the K channels are idle in steps P16 and P17, the radio transmitter/receiver transmits through the radio transmission unit 14 L-bit activation selection signals using ASK (or OOK) modulation (step P19), and then transmits preamble signals and communication data to complete the operation (step P20).

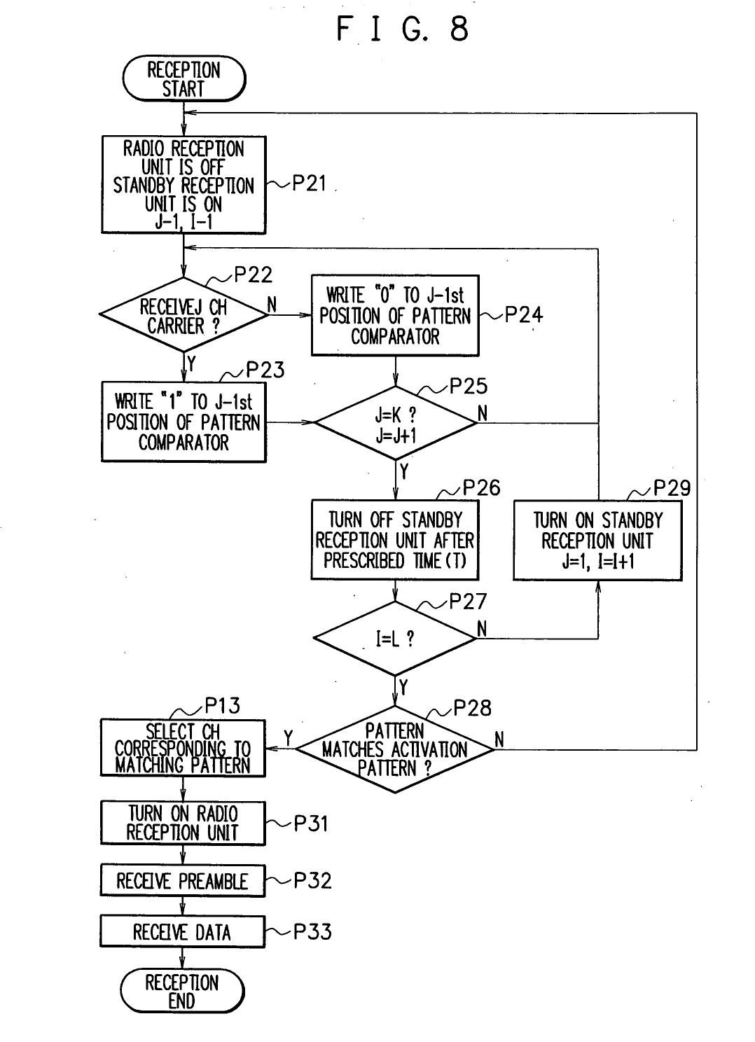

FIG. 8 is a flowchart showing the operation of the other radio transmitter/receiver to be activated by the radio transmitter/receiver of FIG. 6 (the radio transmitter/receiver having the same construction as that of the radio transmitter/receiver of FIG. 6, which is not shown in the drawings) in standby mode.

In standby mode where the standby reception unit (corresponding to the standby reception unit 21 in FIG. 6) is on and the radio reception unit (corresponding to the radio reception unit 13 in FIG. 6) is off, the other radio transmitter/receiver (not shown) subtracts 1 from J as well as subtracting 1 from 1 (1: an integer) (step P21).

The standby reception unit determines whether or not to have received a carrier from a channel (step P22). If a carrier has been received (step P22/Y), the standby reception unit writes “1” to the J-1st position of the pattern comparator (corresponding to the pattern comparator 21 in FIG. 6) (step P23). Then, the standby reception unit determines whether or not J is equal to K and also substitutes J+1 into J (step P25).

If the standby reception unit has not received a carrier from a channel (step P22/Y), the intermittent operation/frequency controller (corresponding to the intermittent operation/frequency controller 23 in FIG. 6) writes “0” to the J-1st position of the pattern comparator (step P24), and performs determination process in step P25.

If J is not equal to K (step P25/N), the process returns to step P22.

After waiting for a prescribed time period (T), the standby reception unit turns off (step P26). The other radio transmitter/receiver determines whether or not I is equal to L (L: the number of bits of an activation pattern=an activation selection signal) (step P27).

If I is equal to L (step P27/Y), the intermittent operation/frequency controller determines whether or not the activation pattern matches I (step P28).

If I is not equal to L (step P27/N), the process returns to step P22.

That is, the standby reception unit scans respective channels for a time period T/N at regular intervals (T) to detect carriers, and writes “1”or “0” as information on the presence or absence of a carrier to the pattern comparator (steps P22 to P29).

At the point when an L-bit pattern has been written to the pattern comparator, if the L-bit pattern written to the pattern comparator matches the activation pattern (activation selection signal) (step P28/Y), the intermittent operation/frequency controller selects the frequency of the channel corresponding to the pattern that matches the activation pattern (step P30). After that, the intermittent operation/frequency controller turns the radio reception unit (corresponding to the radio reception unit 13 in FIG. 6) on (step P31). Thereby, the other radio transmitter/receiver receives a preamble signal (step P32) and data (step P33), thus completing the reception.

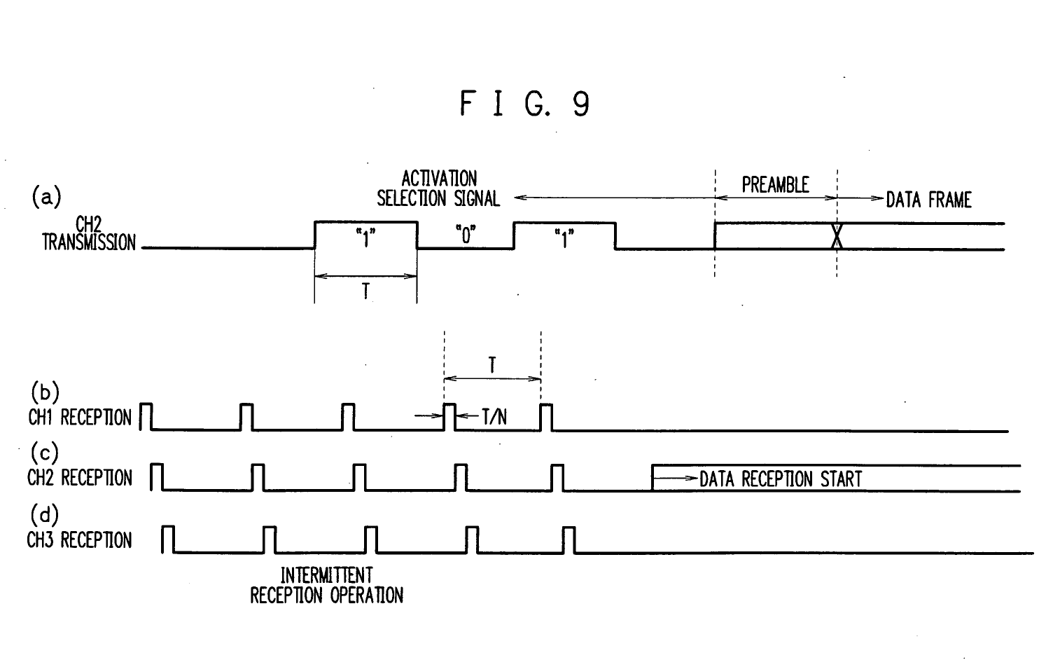

FIGS. 9 (a) to 9 (d) are time charts showing the operation of the radio transmitter/receiver shown in FIG. 6 at the time of intermittent transmission/reception operation in the case where the L-bit activation selection signal is a 3-bit signal: L=3 (“1”, “0”, “1”).

FIG. 9 (a) is a time charts showing transmission through channel 2 (CH2). FIG. 9 (b) is a time charts showing reception through channel 1. FIG. 9 (c) is a time charts showing reception through channel 2. FIG. 9 (d) is a time charts showing reception through channel 3. In FIGS. 9 (a) to 9 (d), the horizontal axis indicates time, while the vertical axis indicates logical level.

As with the radio transmitter/receiver shown in FIG. 1, the radio transmitter/receiver of FIG. 6 can start up reception in a shorter period of time, and requires less reception power.

Incidentally, in the case of collecting data with wireless sensor modules or the like through ad hoc communication, the battery survival time needs to be prolonged by minimizing the standby power consumption in the entire system to reduce average power consumption. The intermittent transmission/reception control method described above is capable of reducing the power consumed by one radio transmitter/receiver. However, in the system as a whole, when the activation of others frequently occurs, even CPU (Central Processing Unit) that consumes a considerable amount of power is activated to recognize ID. Consequently, power is wastefully consumed, which often causes an increase in the average power consumption of the system.

With this point in view, the present inventors have conceived of a method of reducing the standby power consumption in the entire system. According to the method, the radio transmitter/receiver, which transmits signals for intermittent reception or intermittently-received signals before regular communication and is provided with a dedicated receiver for receiving such intermittently-received signals, transmits an activation signal with an ID signal (a group ID signal and/or an individual ID signal) as the intermittently-received signal. Each radio transmitter/receiver recognizes the ID signal at the time of the intermittent reception, thus reducing the standby power in the entire system.

The ASK modulator modulates the amplitude of a carrier (carrier wave) in proportion to baseband data. The ASK modulation is susceptible to noise and interference, and is infrequently used for long-distance data transmission. Nevertheless, since the ASK modulator has a simple configuration and can be easily minimized at low cost, it is used for short-distance communication between weak radio stations (specific small power radio stations) or the like. The ASK modulation is differentiated from the OOK modulation in that the oscillator circuit does not halt regardless of whether data indicates “1” or “0”.

Besides, as with the ASK modulator, the OOK modulator turns on and off a series of carriers with a constant frequency and amplitude. However, differently from the ASK modulation, the oscillator circuit completely halts when carriers are off. Accordingly, it is possible to realize a module that requires less power. Incidentally, the Morse code transmission uses the OOK modulation.

### Another Embodiment

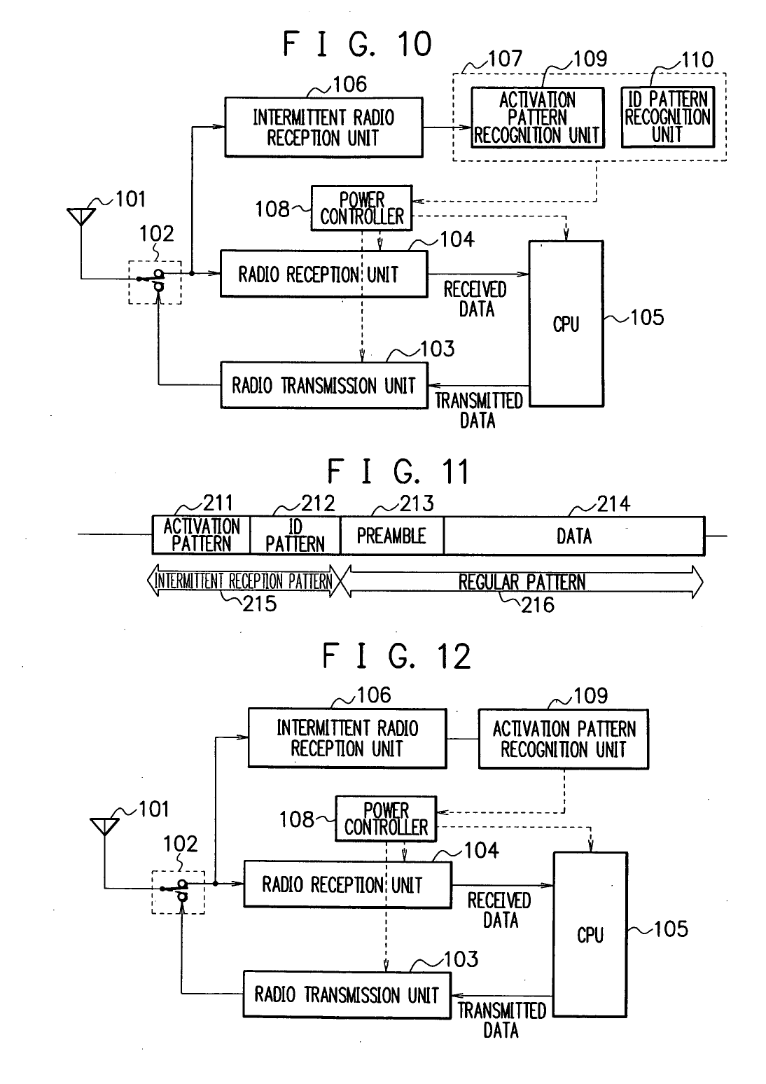

FIG. 10 is a block diagram showing a radio transmitter/receiver to which is applied an intermittent transmission/reception control method for a radio transmitter/receiver according to yet another embodiment of the present invention. The radio transmitter/receiver comprises an antenna 101, a transmission/reception changeover switch SW 102, a radio transmission unit 103, a radio reception unit 104, and a CPU 105. The radio transmitter/receiver further comprises, in addition to the radio reception unit 104, an intermittent radio reception unit 106. The radio transmitter/receiver yet further comprises a pattern recognition unit 107, and a power controller 108 for controlling the power of the CPU 105, the radio transmission unit 103 and the radio reception unit 104 based on a signal from the pattern recognition unit 107. The pattern recognition unit 107 includes an activation pattern recognition unit 109 and an ID pattern recognition unit 110.

### Operation of the Embodiment

FIG. 11 is a diagram showing a transmission/reception pattern when communication is performed between two radio transmitter/receivers having the same construction as shown in the block diagram of FIG. 10.

The radio transmitter/receiver of FIG. 10 in the sending end transmits a transmission pattern as shown in FIG. 11 from the radio transmission unit 103.

The pattern shown in FIG. 11 includes a pattern for intermittent reception or an intermittent reception pattern at the beginning thereof. The intermittent reception pattern consists of an activation pattern 211 and an ID pattern 212. As the activation pattern 211 and the ID pattern 212 may be employed radio modulation patterns such as ASK (Amplitude Shift Keying) and OOK (On/Off Keying) to simplify an intermittent reception circuit and reduce power consumption.

After transmitting the intermittent reception pattern 215 consisting of the activation pattern 211 and the ID pattern 212, the sending radio transmitter/receiver transmits a regular pattern 216 consisting of a preamble 213 and data 214.

In the receiving radio transmitter/receiver, the power of the radio transmission unit 103, the radio reception unit 104, and the CPU 105 is off. The intermittent radio reception unit 106, the pattern recognition unit 107 and the power controller 108 intermittently awake until receiving the activation pattern 211 shown in FIG. 11 from the sending radio transmitter/receiver.

As is described above, the intermittent reception pattern (the activation pattern 211 and the ID pattern 212) is obtained through a modulation system such as ASK or OOK. Therefore, the intermittent radio reception unit 106, which receives the intermittent reception pattern, can be simplified in circuitry and requires less power. When the radio reception unit 104 uses, for example, FSK (Frequency Shift Keying) or the like, even if the intermittent radio reception unit 106 does not intermittently operate, the power consumption is as follows:

“power consumption of the intermittent radio reception unit 106 <power consumption of the radio reception unit 104”

(if the intermittent radio reception unit 106 intermittently operates, “<” is replaced by “<<”).

In the following, a description will be given of the simplification of the circuitry of the intermittent radio reception unit 106.

The simplification indicates that the intermittent radio reception unit 106 can be simplified as compared to the case where so-called FM (Frequency Modulation): frequency shift keying (FSK) or phase shift keying (PSK) is employed. For example, when data “01” is transmitted through ASK or OOK modulation, the intermittent radio reception unit 106 can receive the data “01” only by detecting the strength or intensity of the signal. On the other hand, when the data is transmitted through FSK or PSK modulation, the intermittent radio reception unit 106 has to detect shifts in the frequency and phase. Consequently, the intermittent radio reception unit 106 needs a component such as a band-pass filter (a mechanic filter, a ceramic filter or a crystal filter), thus having intricate circuitry.

For this reason, the circuit size for ASK demodulation can be rendered smaller than that for FSK demodulation, and power consumption can be reduced as follows:

(power consumption in the case of ASK demodulation=power consumption of the intermittent radio reception unit 106)<(power consumption in the case of FSK demodulation=power consumption of the radio reception unit 104).

Having received the activation pattern 211, the intermittent radio reception unit 106 sends the pattern to the pattern recognition unit 107. Since the pattern recognition unit 107 receives the activation patterns asynchronously, it performs start-stop synchronization of the patterns to recognize them. If the activation pattern corresponds to that of the radio transmitter/receiver, the intermittent radio reception unit 106 sends the ID pattern 212 as the next pattern data to the ID pattern recognition unit 110. The ID pattern recognition unit 110 recognizes the ID while performing start-stop synchronization, thereby sending a recognition signal to the power controller 108. The power controller 108 turns on the power of the radio transmission unit 103, the radio reception unit 104, and the CPU 105 according to the recognition signal.

If the pulse width of the intermittent reception pattern is set longer than that of the regular pattern, the pattern recognition unit 107 and power controller 108 sufficiently operate with less power as compared to power consumption of the CPU 105.

### Effect

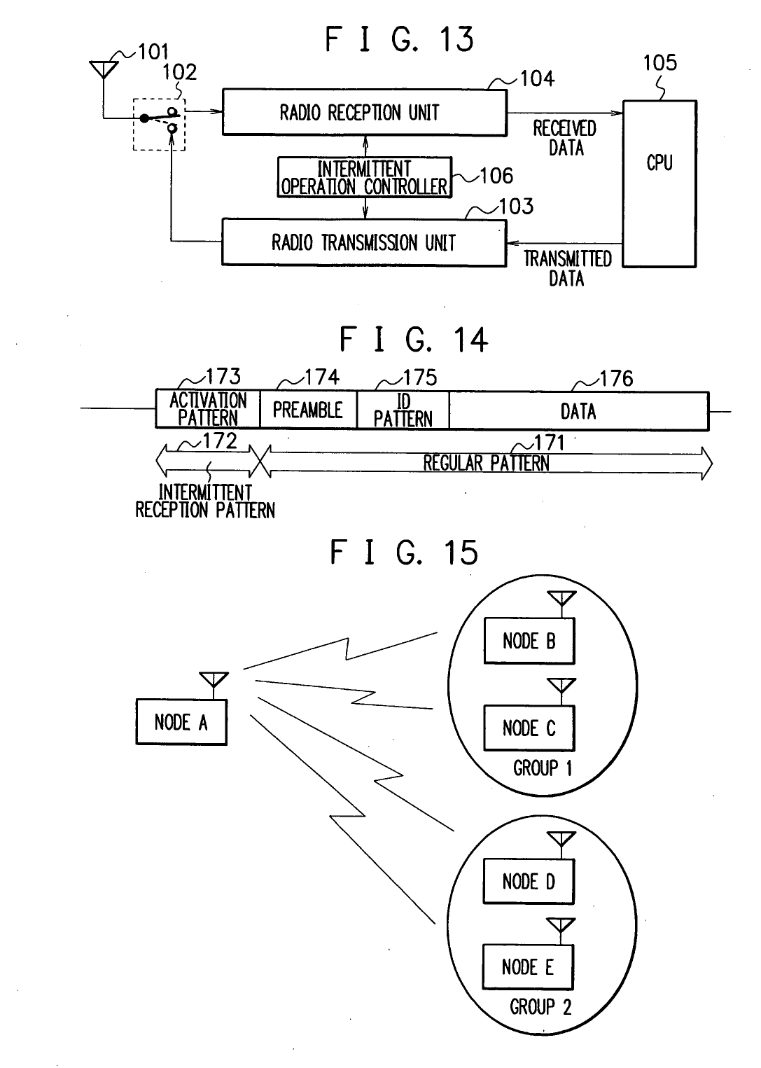

According to a conventional intermittent transmission/reception control method for radio transmitter/receivers as shown in FIGS. 12 and 13, a regular pattern contains an ID pattern. Referring to FIG. 14, a regular pattern 171, subsequent to an intermittent reception pattern 172 consisting of an activation pattern 173, contains an ID pattern 175 in between a preamble 174 and data 176. Therefore, the ID pattern cannot be recognized unless a radio reception unit 104 and a CPU 105, which will be described later, are activated. As such, in FIG. 15, for example, even when a node A intends to activate only a node B, nodes C to E are also activated in the conventional system. All the nodes are awake until their CPUs have recognized the ID pattern contained in the regular pattern. During the period, power is wastefully consumed.

On the other hand, according to the embodiment of the present invention, the intermittent radio reception unit 106, the pattern recognition unit 107 and the power controller 108, which require less power, recognize the ID pattern contained in the intermittent reception pattern. Thereby, the radio reception unit 104 and CPU 105 of only the node B is activated. Thus, it is possible to reduce power consumption in the entire system.

Incidentally, FIGS. 12 and 13 are block diagrams each showing a radio transmitter/receiver to which is applied the conventional intermittent reception control method for a radio transmitter/receiver. FIG. 14 is a diagram showing a transmission/reception pattern when the conventional intermittent reception control method for a radio transmitter/receiver is applied. FIG. 15 is a diagram for explaining the case where the node A activates the node B.

Referring to FIG. 12, the radio transmitter/receiver comprises an antenna 101, a transmission/reception changeover switch 102, a radio transmission unit 103, a radio reception unit 104, and an intermittent radio reception unit 106. Generally, the transmission/reception changeover switch 102 connects the antenna 101 to the intermittent radio reception unit 106. The radio transmitter/receiver performs intermittent reception, and recognizes the presence or absence of an activation pattern through an activation pattern recognition unit 109. When the activation pattern recognition unit 109 recognizes the presence of an activation pattern, a CPU 105 activates a power controller 108 to thereby activate the radio reception unit 104. Thus, the radio reception unit 104 sends received data to the CPU 105. At the time of the transmission, the transmission/reception changeover switch 102 connects the antenna 101 to the radio transmission unit 103 under the control of the CPU 105, and the CPU 105 sends data to be transmitted to the radio transmission unit 103.

Referring to FIG. 13, the radio transmitter/receiver comprises an antenna 101, a transmission/reception changeover switch 102, a radio transmission unit 103, a radio reception unit 104, a CPU 105, and an intermittent operation controller 106. The intermittent operation controller 106 controls the transmission/reception switch. The radio reception unit 104 operates intermittently under the control of the intermittent operation controller 106, and sends received data to the CPU 105. The CPU 105 intermittently sends data to be transmitted to the radio transmission unit 103.

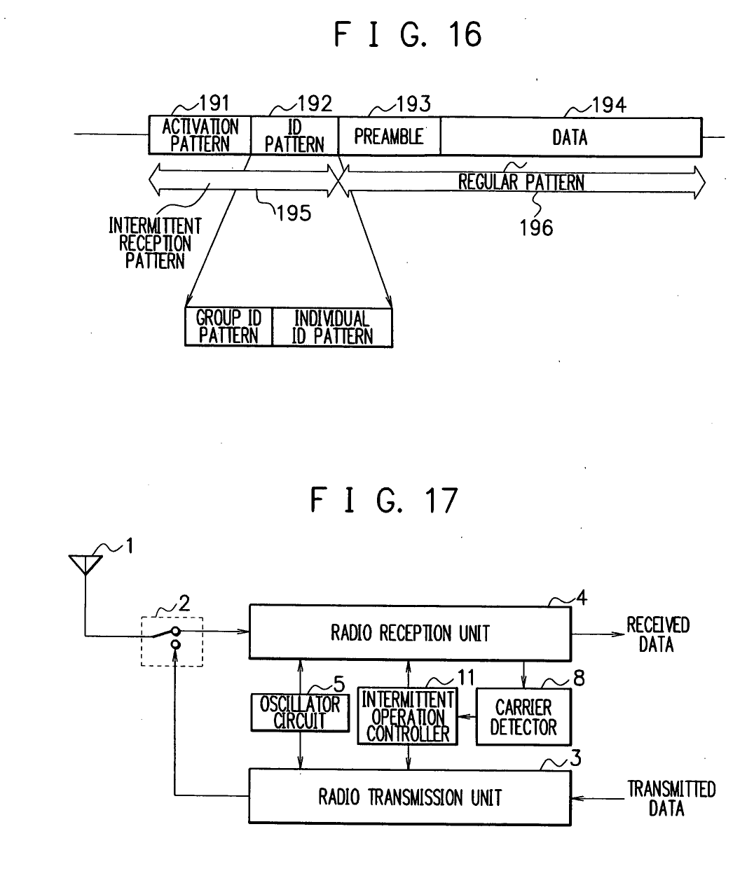

FIG. 16 is a diagram showing a transmission/reception pattern when an intermittent reception control method for a radio transmitter/receiver of the present invention is applied.

Referring to FIG. 16, an intermittent reception pattern 195 consists of an activation pattern 191 and an ID pattern 192. If the ID pattern 192 is separated into a group ID pattern 197 and an individual ID pattern 198 and the patterns 197 and 198 are controlled separately, it is possible to activate only the nodes B and C in group 1 shown in FIG. 15. Thereby, the node A can simultaneously transmit data to the nodes B and C, and need not transmit the same data twice (the node A need not transmit data to the node B first, and then transmit the same data to the node C). Consequently, in the system as a whole, power can be controlled more carefully and meticulously. Incidentally, a regular pattern 196 subsequent to the intermittent reception pattern 195 consists of a preamble 193 and data 194.

### BRIEF DESCRIPTION OF THE DRAWINGS

[FIG. 1] A block diagram showing a radio transmitter/receiver to which is applied an intermittent transmission/reception control method for a radio transmitter/receiver according to an embodiment of the present invention.

[FIG. 2] A block diagram showing an example of a pattern comparator of the radio transmitter/receiver depicted in FIG. 1.

[FIG. 3] A flowchart showing the transmission operation of the radio transmitter/receiver depicted in FIG. 1 for activating another radio transmitter/receiver having the same construction as that of the radio transmitter/receiver depicted in FIG. 1.

[FIG. 4] A flowchart showing the operation of the radio transmitter/receiver to be activated (the other radio transmitter/receiver) in standby mode.

[FIG. 5] FIG. 5 (a) is a time chart showing the operation in steps P3 and P4 of the flowchart shown in FIG. 3; FIG. 5 (b) is a time chart showing the operation at the time of reception.

[FIG. 6] A block diagram showing a radio transmitter/receiver according to another embodiment of the present invention.

[FIG. 7] A flowchart showing the operation of the radio transmitter/receiver for activating another radio transmitter/receiver.

[FIG. 8] A flowchart showing the operation of the radio transmitter/receiver to be activated (the other radio transmitter/receiver) in standby mode.

[FIG. 9] Time charts each showing the operation at the time of transmission or reception for activation.

[FIG. 10] A block diagram showing a radio transmitter/receiver to which is applied an intermittent transmission/reception control method for a radio transmitter/receiver according to yet another embodiment of the present invention.

[FIG. 11] A diagram showing a transmission/reception pattern when communication is performed between two radio transmitter/receivers having the same construction as shown in the block diagram of FIG. 10.

[FIG. 12] A block diagram showing a radio transmitter/receiver to which is applied a conventional intermittent reception control method for a radio transmitter/receiver.

[FIG. 13] A block diagram showing another radio transmitter/receiver to which is applied a conventional intermittent reception control method for a radio transmitter/receiver.

[FIG. 14] A diagram showing a transmission/reception pattern when a conventional intermittent reception control method for a radio transmitter/receiver is applied.

[FIG. 15] A diagram for explaining the case where a node A activates a node B.

[FIG. 16] A diagram showing a transmission/reception pattern when an intermittent reception control method for a radio transmitter/receiver of the present invention is applied.

[FIG. 17] A block diagram showing a radio transmitter/receiver to which is applied a conventional intermittent transmission/reception control method.

[FIG. 18] FIG. 18 (a) is a diagram showing the signal timing at the time of the transmission operation of the radio transmitter/receiver depicted in FIG. 17; FIG. 18 (b) is a diagram showing the signal timing at the time of the reception operation of the radio transmitter/receiver depicted in FIG. 17.

[FIG. 19] FIGS. 19 (a) and 19 (b) each show a preamble where ID=3 bits and N=4 in the radio transmitter/receiver depicted in FIG. 17; FIGS. 19 (c) and 19 (d) each show a received pulse in the same conditions as above.

### DESCRIPTION OF CODES

1, 101 Antenna
2, 102 Transmission/reception changeover switch
3, 103 Radio transmission unit
4, 104 Radio reception unit
5 Oscillator circuit
6 RF demodulator
7 SAW oscillator
8 Carrier detector
9 Pattern comparator
10 Standby reception unit
11 Intermittent operation controller
105 CPU
106 Intermittent radio reception unit
107 Pattern recognition unit
108 Power controller
109 Activation pattern recognition unit
110 ID pattern recognition unit

1. A radio transmitter/receiver which requires less reception standby power, comprising:
a radio reception unit;
a radio transmission unit for transmitting an activation selection signal using ASK modulation or OOK modulation to switch the radio reception unit of another radio transmitter/receiver from intermittent reception mode to continuous reception mode before transmitting a preamble signal thereto; and
a standby reception unit for intermittently performing reception at intervals of a prescribed bit width to receive an activation selection signal from the radio transmission unit of another radio transmitter/receiver, and generating a signal to activate the radio reception unit on receipt of the activation selection signal.

2. The radio transmitter/receiver claimed in claim 1, wherein:
the standby reception unit includes a SAW oscillator for completing reception in a time period of a prescribed bit width from when the power is turned on; and
the use of a signal generated by the SAW oscillator reduces the reception startup time of the radio reception unit.

3. The radio transmitter/receiver claimed in claim 2, wherein the SAW oscillator is provided with a frequency selector for selecting the oscillation frequency thereof.

4. The radio transmitter/receiver claimed in one of claims 1 to 3, further comprising a power controller, wherein:
the radio transmission unit adds an ID signal that specifies the receiver to the activation selection signal;
the standby reception unit determines whether or not the received activation selection signal is addressed to the radio transmitter/receiver based on an ID signal added to the activation selection signal; and
the power controller feeds power to the radio transmission unit and the radio reception unit only when the standby reception unit has determined that the activation selection signal is addressed to the radio transmitter/receiver.

5. The radio transmitter/receiver claimed in claim 4, wherein the ID signal includes a group ID signal and/or an individual ID signal.

6. A radio transmitter, including a radio transmission unit for transmitting an activation selection signal using ASK modulation or OOK modulation to switch the radio reception unit of a radio receiver from intermittent reception mode to continuous reception mode before transmitting a preamble signal thereto.

7. The radio transmitter claimed in claim 6, wherein the radio transmission unit adds an ID signal that specifies the receiver to the activation selection signal.

8. A radio receiver which requires less reception standby power, comprising:
a radio reception unit; and
a standby reception unit for intermittently performing reception at intervals of a prescribed bit width to receive an activation selection signal transmitted using ASK modulation or OOK modulation prior to a preamble signal, and generating a signal to activate the radio reception unit on receipt of the activation selection signal.

9. The radio receiver claimed in claim 8, wherein:
the standby reception unit includes a SAW oscillator for completing reception in a time period of a prescribed bit width from when the power is turned on; and
the use of a signal generated by the SAW oscillator reduces the reception startup time of the radio reception unit.

10. The radio receiver claimed in claim 9, wherein the SAW oscillator is provided with a frequency selector for selecting the oscillation frequency thereof.

11. The radio receiver claimed in one of claims 8 to 10, further comprising a power controller, wherein:
the standby reception unit determines whether or not the received activation selection signal is addressed to the radio receiver based on an ID signal added to the activation selection signal; and
the power controller feeds power to a radio transmission unit and the radio reception unit only when the standby reception unit has determined that the activation selection signal is addressed to the radio receiver.

12. The radio receiver claimed in claim 11, wherein the ID signal includes a group ID signal and/or an individual ID signal.

13. An intermittent transmission/reception control method applied to a radio transmitter/receiver comprising a radio reception unit, a radio transmission unit and a standby reception unit for reducing reception standby power, the method comprising the steps of:
the radio transmission unit transmitting an activation selection signal using ASK modulation or OOK modulation to switch the radio reception unit of another radio transmitter/receiver from intermittent reception mode to continuous reception mode before transmitting a preamble signal thereto;
the standby reception unit intermittently performing reception at intervals of a prescribed bit width to receive an activation selection signal from the radio transmission unit of another radio transmitter/receiver; and
the standby reception unit generating a signal to activate the radio reception unit on receipt of the activation selection signal.

14. The intermittent transmission/reception control method claimed in claim 13, wherein the standby reception unit includes a SAW oscillator for completing reception in a time period of a prescribed bit width from when the power is turned on, the method further comprising the step of the standby reception unit using a signal generated by the SAW oscillator to reduce the reception startup time of the radio reception unit.

15. The intermittent transmission/reception control method claimed in claim 14, wherein the SAW oscillator is provided with a frequency selector, the method further comprising the step of the frequency selector selecting the oscillation frequency of the SAW oscillator.

16. The intermittent transmission/reception control method claimed in one of claims 13 to 15, further comprising the steps of:
the radio transmission unit adding an ID signal that specifies the receiver to the activation selection signal;
the standby reception unit determining whether or not the received activation selection signal is addressed to the radio transmitter/receiver based on an ID signal added to the activation selection signal; and
a power controller feeding power to the radio transmission unit and the radio reception unit only when the standby reception unit has determined that the activation selection signal is addressed to the radio transmitter/receiver.

17. The intermittent transmission/reception control method claimed in claim 16, wherein the ID signal includes a group ID signal and/or an individual ID signal.

18. An intermittent transmission control method, comprising the step of the radio transmission unit of a radio transmitter transmitting an activation selection signal using ASK modulation or OOK modulation to switch the radio reception unit of a radio receiver from intermittent reception mode to continuous reception mode before transmitting a preamble signal thereto.

19. The intermittent transmission control method claimed in claim 18, further comprising the step of the radio transmission unit adding an ID signal that specifies the receiver to the activation selection signal.

20. An intermittent reception control method for reducing reception standby power, comprising the steps of:
the standby reception unit of a radio receiver intermittently performing reception at intervals of a prescribed bit width to receive an activation selection signal transmitted using ASK modulation or OOK modulation prior to a preamble signal; and
the standby reception unit generating a signal to activate the radio reception unit of the radio receiver on receipt of the activation selection signal.

21. The intermittent reception control method claimed in claim 20, wherein the standby reception unit includes a SAW oscillator for completing reception in a time period of a prescribed bit width from when the power is turned on, the method further comprising the step of the standby reception unit using a signal generated by the SAW oscillator to reduce the reception startup time of the radio reception unit.

22. The intermittent reception control method claimed in claim 21, wherein the SAW oscillator is provided with a frequency selector, the method further comprising the step of the frequency selector selecting the oscillation frequency of the SAW oscillator.

23. The intermittent reception control method claimed in one of claims 20 to 22, further comprising the steps of:
the standby reception unit determining whether or not the received activation selection signal is addressed to the radio receiver based on an ID signal added to the activation selection signal; and
a power controller feeding power to a radio transmission unit and the radio reception unit only when the standby reception unit has determined that the activation selection signal is addressed to the radio receiver.

24. The intermittent reception control method claimed in claim 20, wherein the ID signal includes a group ID signal and/or an individual ID signal.
